(19) United States
(12) Patent Application Publication
(10) Pub. No.: US 2021/0248603 A1
(43) Pub. Date: Aug. 12, 2021

(54) BLOCKCHAIN-BASED TRANSACTION PROCESSING METHOD AND APPARATUS

(71) Applicant: ELAND BLOCKCHAIN FINTECH INC., San Jose, CA (US)

(72) Inventors: Ching Song WU, Taipei City (TW); Chun-Wei YU, New Taipei City (TW); Chih Sheng WANG, New Taipei City (TW); Yi Hung LIANG, Taipei City (TW); Cheng-Ying WU, New Taipei City (TW)

(21) Appl. No.: 17/239,804

(22) Filed: Apr. 26, 2021

Related U.S. Application Data
(63) Continuation-in-part of application No. 16/492,706, filed on Sep. 10, 2019, now abandoned.
(60) Provisional application No. 62/537,523, filed on Jul. 27, 2017.

(51) Int. Cl. G06Q 20/38; G06Q 20/40; G06Q 20/22; H04L 9/06; H04L 9/08

(52) U.S. Cl. CPC G06Q 20/389; G06Q 20/401; H04L 2209/38; H04L 9/0643; H04L 9/0819; G06Q 20/223

(57) ABSTRACT

A block chain-based transaction processing method and apparatus are disclosed, in which an intermediate computing device receives and validates a first block record from, and generates and sends a second block record to, a first computing device; receives a third block record generated by a second computing device after validating the second block record from the intermediate computing device; generates and sends a fourth block record to the second computing device after validating the third block record, receives from the first computing device a fifth block record generated by the first computing device after validating the fourth block record from the intermediate computing device; receives from the second computing device a sixth block record generated by the second computing device after validating the fifth block record from the intermediate computing device; and broadcasts the first to sixth block records to other computing devices after validating the fifth and sixth block records.

This is a CIP application of application of Ser. No. 16/492,706, filed on Jul. 25, 2018, entitled “Electronic transaction system and method using a blockchain to store transaction records,” which is hereby incorporated by reference.

### BACKGROUND OF THE INVENTION

### 1. Field of the Invention

The present invention relates to a blockchain-based transaction processing method and apparatus, in particular to a method and apparatus for processing and recording transaction events using a blockchain network.

### 2. Description of the Related Art

Blockchain technology (also known as distributed ledger technology) has the unique features of decentralization, transparency, openness, tamper-resistance, and dependability, and thus grows in popularity. Besides the well-known Bitcoin, the blockchain technology is widely applied to e-commerce, social communications, file storage, identity authentication, and equity crowdfunding.

However, the existing blockchain technology has limitations, in particular in the aspects of processing and recording transactions. The existing blockchain technology is incapable of being integrated with the real economy accounting system, and thus can only be used as an independent cryptocurrency transaction system. Moreover, existing blockchain transaction processing systems are unilateral and one-way transactions, lacking a consensus mechanism, and cannot obtain the consensus of both parties in advance, particularly the consensus record that can be validated afterwards.

The processing and recording of the transactions in the existing blockchain are explained briefly below:

Step 1: A new transaction is requested and authenticated, in which a user uses his/her own private key and a public key both to create a secure digital identity and authenticate the user via digital signatures and to ‘unlock’ the transaction to be performed;

Step 2: Create a block representing that transaction is created, that is, all transaction information is filed to form a block record;

Step 3: The block is sent (broadcast) to every node (i.e. participant) in the network;

Step 4: The nodes validate the transaction block;

Step 5: The node receives a reward for proof of work, typically in cryptocurrency;

Step 6: The block is added to the existing blockchain; and

Step 7: The update is distributed across the network, and the transaction is completed.

As mentioned above, after a transaction is initiated by a single party, it is validated and recorded by other nodes. The counterparty of the transaction can only passively accept it, and sometimes even unaware of it. For example, in the case that Bob wants to allocate 1 bitcoin to Alice, the primary record of the transaction block will only show that the payer Bob paid the payee Alice 1 bitcoin. In other words, as long as the grantor unilaterally executes the grant, the transaction is completed. There is no record of agreement or consensus between the two parties involved in the transaction, and thus it is not possible to verify the transaction record afterward. The recipient cannot refuse but to accept the transaction. As such, there are considerable risks underlying the transaction, and such a transaction is inconsistent with the consensual principles long existing in commercial transactions.

Furthermore, the transaction record of the existing blockchain encrypted currency is managed by using the running balance ledger format. The content of the transaction record mainly includes the transaction amount, the public keys of both parties to the transaction, and the private key signature of the initiator. However, most of the existing accounting systems, namely the real economy accounting systems, use the double entry bookkeeping method, and hence the blockchain transaction records recorded by the running account method are unable to linked to the records of the real economy accounting system recorded by the double entry bookkeeping method. That is to say, the blockchain transaction records cannot enter into the existing real economy accounting system. This is one of the main reasons why the cryptocurrency of blockchain is unable to be fully used in the existing commercial economic activities. In addition, the existing real economy accounting system with its inherent accounting method is different from the method of recording transactions in the existing blockchain. Therefore, the existing accounting system using the double-entry bookkeeping method is still unable to account and process transactions, by using the blockchain technology.

### SUMMARY OF THE INVENTION

A primary object of the present invention is to provide a blockchain-based transaction processing method and apparatus, which may record a consensus process between two parties during the transaction. The process may be verified by any interested parties thereafter, is completely transparent, and undeniable, that is, cannot be tampered with. As such, the transactions are manageable, and a stable and orderly transaction can be established.

A further object of the present invention is to provide a blockchain-based transaction processing method and apparatus, which can integrate the transaction records of the blockchain with the real economy accounting system of fiat currency transactions, so that blockchain transactions can be integrated with the real commercial activities. This would successfully solve the long existing problem where the blockchain ledger recorded by the running account method cannot be integrated with the commercial transaction records of the real world.

To achieve the above and other objects, the present invention provides a computer-implemented method for processing a transaction. The method comprises the steps of: receiving, by an intermediate computing device, a first block record from a first computing device in a peer-to-peer network, wherein the first block record comprises a transaction initiator, a plurality of transaction attenders, and a transaction amount receivable or payable; generating, by the intermediate computing device, a second block record and sending the second block record to the first computing device after the intermediate computing device have validated the first block record; receiving, by the intermediate computing device, from a second computing device a third block record that is generated by the second computing device after having validated the second block record obtained from at least one of the first computing device and the intermediate computing device, wherein the third block record comprises the transaction initiator, the transaction attenders, and a further transaction amount receivable or payable, wherein when the transaction amount payable is recorded in the first block record, the further transaction amount receivable is recorded in the third block, and sum of the transaction amount payable recorded in the first block record and the further transaction amount receivable recorded in the third block record is zero; generating, by the intermediate computing device, a fourth block record and sending the fourth block record to the second computing device after validating the third block record; receiving, by the intermediate computing device, from the first computing device a fifth block record that is generated by the first computing device after having validated the fourth block record obtained from at least one of the second computing device and the intermediate computing device; receiving, by the intermediate computing device, from the second computing device a sixth block record that is generated by the second computing device after having validated the fifth block record obtained from at least one of the first computing device and the intermediate computing device in the peer-to-peer network; and broadcasting, by the intermediate computing device, the first, second, third, fourth, fifth, and sixth block records to other computing devices in the peer-to-peer network after having validated the fifth and sixth block records.

To achieve the above objects, the present invention provides a computer-implemented system for processing a transaction. The system comprises an intermediate computing device, and one or more memory devices which are communicatively coupled to the intermediate computing device and have tangible, non-transitory, machine-readable medium storing one or more instructions that, when executed by the intermediate computing device, perform the operations including: receiving, by the intermediate computing device, a first block record from a first computing device, wherein the first block record comprises a transaction initiator, multiple transaction attenders, and a transaction amount receivable or payable; generating, by the intermediate computing device, a second block record and sending the second block record to the first computing device after the intermediate computing device validates the first block record; receiving, the intermediate computing device, from a second computing device a third block record that is generated by the second computing device after having validated the second block record obtained from at least one of the first computing device and the intermediate computing device, wherein the third block record comprises the transaction initiator, the transaction attenders, and a further transaction amount receivable or payable, wherein when the first block record records the transaction amount payable, the third block record records the further transaction amount receivable, and sum of the transaction amount payable recorded in the first block record and the further transaction amount receivable record in the third block record is zero; generating, by the intermediate computing device, a fourth block record and sending the fourth block record to the second computing device after validating the third block record; receiving, by the intermediate computing device, from the first computing device a fifth block record that is generated by the first computing device after having validated the fourth block record obtained from at least one of the second computing device and the intermediate computing device; receiving, by the intermediate computing device, from the second computing device a sixth block record that is generated by the second computing device after having validated the fifth block record obtained from at least one of the first computing device and the intermediate computing device; and sending, by the intermediate computing device, the first, second, third, fourth, fifth, and sixth block records to other computing devices after validating the fifth and sixth block records.

To achieve the above objects, the present invention provides a tangible, non-transitory, machine-readable medium storing one or more instructions that, when executable by an intermediate computing device, perform the operations including: receiving, by the intermediate computing device, a first block record from a first computing device in the peer-to-peer network, wherein the first block record comprises a transaction initiator, a plurality of transaction attenders, and a transaction amount receivable or payable; generating, by the intermediate computing device, a second block record and sending the same to the first computing device after the intermediate computing device validates the first block record; receiving, by the intermediate computing device, from a second computing device a third block record that is generated by the second computing device after having validated the second block record obtained from at least one of the first computing device and the intermediate computing device, wherein the third block record comprises the transaction initiator, the transaction attenders, and a further transaction amount receivable or payable, wherein when the first block record records the transaction amount payable, the third block record records the further transaction amount receivable, and sum of the transaction amount payable recorded in the first block record and the further transaction amount receivable recorded in the third block record is zero; generating, by the intermediate computing device, a fourth block record and sending the same to the second computing device after validating the third block record; receiving, by the intermediate computing device, from the first computing device a fifth block record that is generated by the first computing device after having validated the fourth block record obtained from at least one of the second computing device and the intermediate computing device; receiving, by the intermediate computing device, from the second computing device a sixth block record that is generated by the second computing device after having validated the fifth block record obtained from at least one of the first computing device and the intermediate computing device; and sending, by the intermediate computing device, the first, second, third, fourth, fifth, and sixth block records to other computing devices after validating the fifth and sixth block records.

Accordingly, the present invention uses the first, second, third, fourth, fifth, and sixth block records to confirm the transaction between the two parties, wherein, the first block record is a transaction request initiated by the transaction initiator, the third block record is issued by an attender in response to the transaction request, while the second, fourth, fifth, and sixth block records are used to record the process that a consensus is reached by both parties. Therefore, the present invention y record completely the entire process that a consensus is reached by both transaction parties. The records are completely transparent and may be verified by any interested party thereafter. The records are undeniable and cannot be tampered with,

In addition, the present invention records the amounts receivable or payable of both parties in the first and third block records, and the amounts receivable and amounts payable must correspond to each other, that is, the sum of the amounts receivable and amounts payable must be zero. Such an approach is in line with the double entry bookkeeping method adopted, by the existing accounting system. In other words, the transaction records made on the basis of the method or system of the present invention can be integrated with the real economy accounting system, that is, the transaction records may enter the real economy accounting system. Furthermore, the transaction records of the real economy accounting system can even enter the existing blockchain ledger using the method or system of the present invention.

Furthermore, the scope and scale of transaction events that can be processed by the present invention is not limited. For example, any node in the blockchain may process transaction events among other nodes. Moreover, the intricate transaction events among multiple user nodes can be easily clarified and processed. That is to say, the equity relationships and transaction records among different users may be disclosed sufficiently in the blockchain, and anyone interested can make clearing and settlement, and also, certainly may have an access to the assets and liabilities of specific users by clearing.

### BRIEF DESCRIPTION OF THE DRAWINGS

FIG. I schematically shows a first embodiment according to the present invention in which the blockchain is implemented.

FIG. 2A schematically shows a flowchart of the first embodiment according to the present invention.

FIG. 2B is a processing flowchart of the first embodiment according to the present invention.

FIG. 3 schematically shows the data structure of the block record in the first embodiment according to the present invention.

FIG. 4 schematically shows a transaction scenario of users in the second embodiment according to the present invention.

FIG. 5 schematically shows a computing device for various embodiments according to the present invention.

### DESCRIPTION OF THE PREFERRED EMBODIMENTS

The present invention is related to a blockchain-based transaction processing method and apparatus. In the description, similar elements will be denoted by the same reference numerals. In addition, the drawings of the present invention are illustrative, and are not necessarily drawn to scale, and all details are not necessarily be shown in the drawings.

Blockchains typically comprise a public blockchain, a private blockchain, and a consortium blockchain. Further, there may be a combination of the above, such as a combination of the private blockchain and consortium blockchain, and a combination of the consortium blockchain and public blockchain, etc. However, the method and system according to the present invention are applicable to all kinds of blockchains. In other words, any electronic device associated with any of the nodes in the existing blockchains can be used in the method and system of the present invention. A typical implementation device is a computing device with a processor and a storage unit, and the computing device may be a personal computer, a laptop computer, a desktop computer, a cellular phone, a smart phone, a personal digital assistant, a media player, a navigation device, an email sending and receiving device, and a game console, a tablet computer, a wearable device, or an arbitrary combination of these mentioned above.

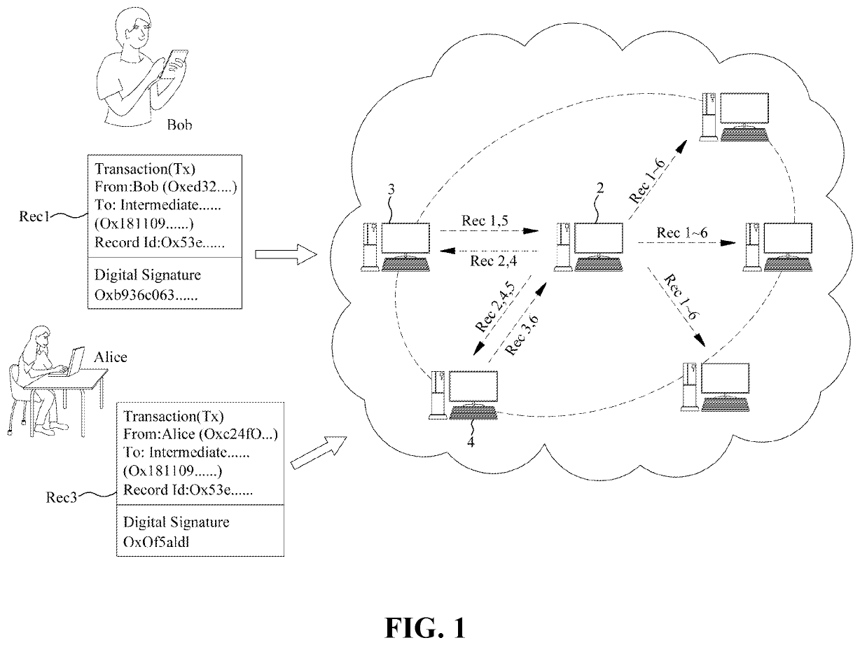

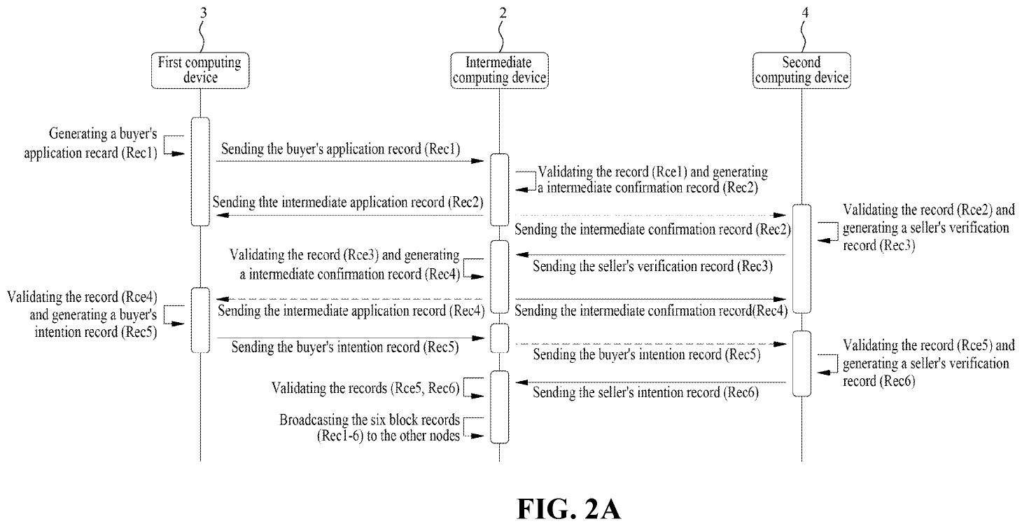

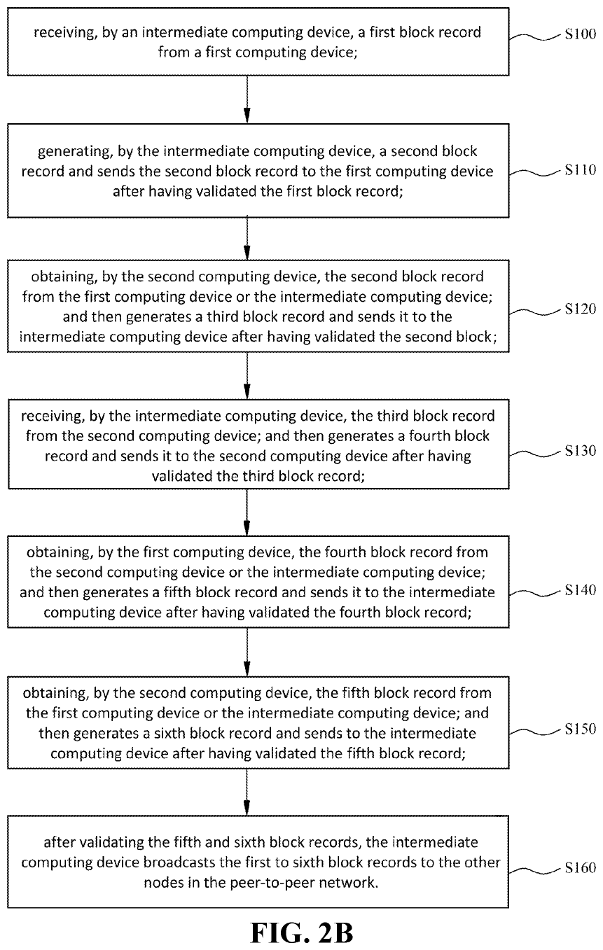

Firstly, reference is made to FIG. 1, FIG. 2A and FIG. 2B, in which FIG. 1 schematically shows a first embodiment according to the present invention in which the blockchain is implemented, FIG. 2A schematically shows a flowchart of the first embodiment according to the present invention, and FIG. 2B is a processing flowchart of the first embodiment according to the present in ion. This embodiment presents the business relationship between two users. In this case, Bob buys a batch of goods from Alice for USD 5,000, in which USD 1,000 has been paid in advance by cash, and the amount to be paid is USD 4,000.

In this embodiment, Bob uses the first computing device 3, Alice uses the second computing device 4, and both of the first computing device 3 and the second computing device 4 are nodes in the public blockchain network (peer-to-peer network). The blockchain network also includes an intermediate computing device 2 and other node devices. The intermediate computing device 2 can be any node device in the blockchain network other than the first and second computing devices. For example, by providing cryptocurrency as a reward, other user nodes may be willing to voluntarily act as the intermediate computing device 2. In an alternate embodiment, a private blockchain or a consortium blockchain can be adopted. The intermediate computing device 2 can be a server dedicated to processing transactions and accounting, for example a bank server, a credit card center, or other accounting data processing servers. In other words, the present invention is also applicable to a centralized network configuration.

Firstly, in step S100, Bob uses the first computing device 3 to send a first block record Recl to the intermediate computing device 2. The first block record is a buyer's application record. Then, in step S110, after receiving the first block record Recl, the intermediate computing device 2 validates the first block record Recl, and generates a second block record Rec2 and sends the second block record Rec2 to the first computing device 3. The second block record Rec2 is an intermediate confirmation record.

On the other hand, Alice's second computing device 4 obtains the second block record Rec2 from the first computing device 3 or the intermediate computing device 2 in the peer-to-peer network. In this embodiment, the intermediate computing device 2 is initiated to send the second block record Rec2 to the second computing device 4. When the second computing device 4 receives the second block record Rec2, the second computing device 4 validates the second block record Rec2 and generates a third block record Rec3, and sends the third block record Rec3 to the intermediate computing device 2, as in step S120. The third block record Rec3 is the record for the seller's verification record.

Next, in step S130, after the intermediate computing device 2 receives the third block record Rec3 from the second computing device 4, the intermediate computing device 2 validates the third block record Rec3, generates a fourth block record Rec4, and sends the fourth block record Rec4 to the second computing device 4. The fourth block record Rec4 is an intermediate confirmation record.

Further, in step S140, the first computing device 3 obtains the fourth block record Rec4 from the second computing device 4 or the intermediate computing device 2 in the peer-to-peer network. In this embodiment, the intermediate computing device 2 is initiated to send the fourth block record Rec4 to the first computing device 3. When the first computing device 3 receives the fourth block record Rec4, the first computing device 3 validates the fourth block record Rec4 and generates a fifth block record Rec5, which is then sent to the intermediate computing device 2. The fifth block record Rec5 is a buyer's intention record, which implies that the buyer has agreed to the transaction finally.

Furthermore, the second computing device 4 obtains the fifth block record Rec5 from the first computing device 3 or the intermediate computing device 2 in the peer-to-peer network. According to this embodiment, in step S150, the intermediate computing device 2 is initiated to send the fifth block record Rec5 to the second computing device 4. When the second computing device 4 receives the fifth block record Rec5, the second computing device 4 validates the fifth block record Rec5 and generates a sixth block record Rec6 which is then sent to the intermediate computing device 2. The sixth block record Rec6 is a seller's intention record, which implies that the seller has agreed to the transaction finally.

Finally, in step S160, after validating the fifth and sixth block records Rec5 and Rec6, the intermediate computing device 2 broadcasts the first to sixth block records Rec1-6 to the other nodes in the peer-to-peer network. When the computing devices of other nodes receive all the block records (Recl-6), they will validate the block records. After validation, the block records will be added to the existing blockchain, and the updates are distributed over the entire network.

Among the block records, the first block record Recl and the third block record Rec3, respectively, record the buyer and seller's descriptions regarding the transaction. The second, fourth, fifth, and sixth block records Rec 2, 4, 5 and 6 are used to record the procedures of reaching a consensus on the transaction between the buyer and the seller. The first and fifth block records Recl and Rec5 are generated by the private key of the first computing device 3. The third and sixth block records Rec3 and Rec6 are generated by the private key of the second computing device 4. The second and fourth block records Rec2 and Rec4 are generated by the private key of the intermediate computing device 2. Therefore, both parties in the transaction sign with their own private keys to confirm that a consensus on the transaction has been reached between the buyer and the seller. The process can be verified by any node in the blockchain afterwards, and is undeniable as it is completely open and transparent. Although steps or procedures of the afore-mentioned embodiments are described in a specific sequence, some of the steps or procedures may not necessarily be performed in this specific sequence. Some of the steps or procedures may be performed in a reversed sequence or be performed simultaneously.

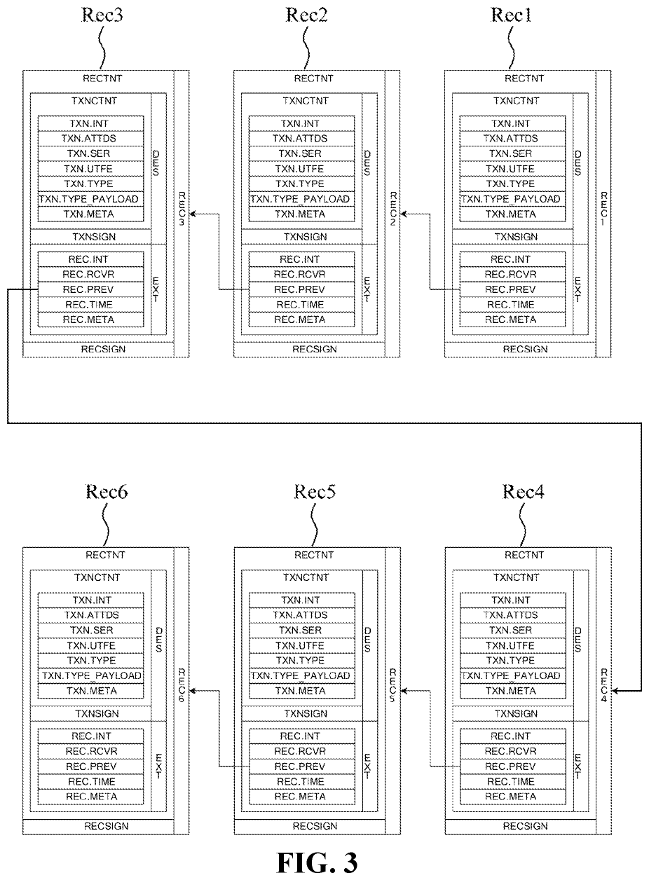

Reference is made to FIG. 3, which schematically shows a data structure of the block record in the first embodiment of the present invention. As shown in the figure, the entire transaction in this embodiment is composed of six process records, that is, the first to sixth block records Rec1-6 mentioned hereinbefore. The data structure of each block record is substantially the same, with only slight differences in the recorded contents. Taking the first block record Recl as an example, the first block record Recl comprises a process identification code (not shown), a record content RECTNT, and a corresponding record signature RECSIGN. The record signature RECSIGN is obtained by the signature of a private key of the first computing device 3, and the process identification code is the hash value of the record content RECTNT using Hash Algorithm-3 (256 bit digest). In particular, the process identification code is a unique identification code associated with a transaction process, that is, the unique identification code of the first block record Recl.

The record content RECTNT is composed of a transaction identification section DES and an extension section EXT. The transaction identification section DES is for recording the basic information of the transaction processed, and the extension section EXT is for recording the procedure information of the transaction processed. The transaction identification section DES includes a transaction content TXNCTNT and a transaction signature TXNSIGN generated by the private key of the transaction initiator TXN.INT (i.e. Bob). The transaction content TXNCTNT includes a transaction identification code (not shown), the transaction initiator TXN.INT, three transaction attenders TXN.ATTDS, a transaction serial number TXN.SER, the anticipated transaction process flow TXN.UTFE of the transaction, the transaction type TXN.TYPE of the transaction, the transaction content TXN.TYPE PALOAD of the transaction, and the remarks associated with the transaction TXN.META. The transaction identification code TXNCTNT.ID is a hash value (SHA3-256) of the transaction content TXNCTNT that excludes the transaction identification code TXNCTNT.ID.

On the other hand, the extension section EXT includes a process initiator REC.INT, a process recipient REC.RCVR, a pre-process identification code REC.PREV, a process time point REC.TIME, and the remarks of the process REC.META. The remarks of the process REC.META in the first block record Recl of this embodiment further records the account codes corresponding to the transaction amount payable, and the transaction amount to be paid by the buyer of this transaction (i.e. Bob). However, in the block records other than the first and third block records Recl and Rec3, the remark REC.META may be a blank. Further, the record signature RECSIGN is generated by the private key of the process initiator (i.e. Bob). Moreover, an account code (or account number) represents the nature of each transaction, including revenue and expense, asset and liability. However, the account codes used in this embodiment comply with IFRS (International Financial Reporting Standards) so that the transaction records of the blockchain can be integrated with the accounting system of fiat currency transactions.

In the present embodiment, the first computing device 3 may provide the following exemplary first block record Recl, which is substantially in the form of a (Secure) Hypertext Transfer Protocol (“HTTP(S)”) POST message including eXtensible Markup Language (“XML”) formatted data, according to the following:

```
<?xml version=″1.0″ encoding=″UTF-8″?>
<record id=″0xd53e008a1522b15b0998b2aa63d633b130fe9c6dc5b0738c2f36691f95de8c96″>
  <rectnt>
    <descriptor>
      <txnctnt id=″0x429d943553d9e68a8b46902d4d184c0ddf38d727e480aa6adcccc8ee3eb02cd1″>
      <initiator>0xed32eb0499c2938793f42444f57befbb892264d4</initiator><!-- Bob -->
      <attenders>
      <attender><address>0xc24f05c5bfd44379a3afa7564be68cc4c2c8a3f8</address></attender>
<!-- Alice -->
      <attender><address>0xed32eb0499c2938793f42444f57befbb892264d4</address></attender>
<!-- Bob -->
      <attender><address>0x181109e6885f0ca0b00bb3a827716d52ac0ae8d7</address></attender>
<!-- Intermediate Computing Device --></attenders>
      <serial>0x0E</serial>
      <utfe ver=″1″>[1:2]([0:2][2:0][2:1]|[2:0][0:2][2:1])([1:2][0:2][0:2][1:2])</utfe>
      <type>0x01</type>
      <typepayload><null/></typepayload>
      <meta><memo>Buy cargo from Alice on 2021 Jan. 30</memo></meta></txnctnt>
      <txnsign><signature>0xc397a77ab67433c78ca54055bc3f0174291e23ceae89f19247ee7340c2b5
298f</signature></txnsign> <!-- txnctnt signature generated by Bob -->
  </descriptor>
      <ext>
<initator><address>0xed32eb0499c2938793f42444f57befbb892264d4</address></initiator>
<receiver><address>0x181109e6885f0ca0b00bb3a827716d52ac0ae8d7</address></receiver>
<prev><txnid>0x0000000000000000000000000000000000000000000000000000000000000000</txni
d></prev>
      <timestamp>1612293105959</timestamp>
      <meta>
      <subjects>
      <subject type=″0x0457″ currency=″usd″>1000</subject> <!-- −1000 -->
      <subject type=″0x085D ″ currency=″usd″>4000</subject> <!-- −4000 -->
      <subject type=″0x04C5″ currency=″usd″>5000</subject> <!-- +5000 -->
      </subjects>
      </meta></ext></rectnt>
      <recsign><signature>0xb936c063e53c0233b6a773cf62281cc0f51b7d6dc4480ed0b0861dc26cb
24fe9</signature></recsign> <!-- rectnt signature generated by Bob --></record>
```

With reference to the above, XML data format file, “<record id>” refers to the “process identification code”; “<txnctnt id>” refers to the “transaction identification code”; “<attender><address>” records the user account addresses of Alice, Bob, and intermediate computing device 2, typically the user public key; “<serial>” refers to the “transaction serial number TXN.SER”; “<utfe >” refers to the “anticipated transaction process flow TXN.UTFE”, which is the procedure flow of the overall transaction (including the first to sixth block records Rec1-6). Taking this embodiment as an example, it records:

“[1:2]([0:2][2:0][2:1]|[2:0][0:2][2:1])([1:2][0:2]|[0:2] [1:2])”,

where 0, 1, 2 represent the respective users in the <attender>field, which are the user account addresses of Alice, Bob, and the intermediate computing device 2, respectively. [1:2] indicates that Bob (Bob) has sent a first block record Rec1 to the intermediate computing device 2;“ ”represents an alternate process, which is “OR”. For example, “([1:2][0:2]|[0:2][1:2])” means that Alice sends the sixth block record Rec6 to the intermediate computing device 2 after Bob has sent the fifth block record Rec5 to the intermediate computing device 2, or alternatively, Bob sends the fifth block record Rec5 to the intermediate computing device 2 after Alice has sent the sixth block record Rec6 to the intermediate computing device. In addition, “<type>” refers to “transaction type TXN.TYPE”; “<typepayload>” is “transaction content TXN.TYPE_PALOAD”; and “<meta>” is “Remarks TXN.META”.

Furthermore, “<ext>” refers to the extension section EXT; “<initator><address>” refers to the “process initiator REC.INT” which, in this process, is Bob's account address; “<receiver><address>” represents the “recipient of the process REC.RCVR”, which, in this process, is “intermediate computing device 2”; and “<prev><txnid>” is the “pre-process identification code REC.PREV”. Since this process is the initial record of this transaction, it is “0”. “<timestamp>” refers to the “process time point REC.TIME”, the time point on which this block record is established; and “<meta>” refers to the “remarks of the process REC.META”. In particular, three pieces of information are recorded in <meta>of the extension section EXT of this block record, in which “0x0457” is a decimal to hex conversion result of the IFRS account code “cash in advance”, which means that USD 1,000 has been paid in cash, and “0x085D” is a decimal to hex conversion result of the IFRS account code “amount payable”, which means that the amount to be paid is USD 4,000; and “0x04C5” is a decimal to hex conversion result of the IFRS account code “inventory”, which means that the complete transaction of the goods purchased is USD 5,000. The coding method for the account code will be described with reference to the second embodiment below. Finally, “<recsign><signature>” refers to the “record signature RECSIGN”, which is generated by the private key of the process initiator (i.e. Bob).

Furthermore, after the intermediate computing device 2 has received the first block record Recl, except for the regular validation items performed in the blockchain, the following items will also be validated: (i) whether the transaction initiator TXN.INT is consistent with the process initiator REC.INT; (ii) whether the transaction initiator TXN.INT is one of the three transaction attenders TXN.ATTDS; (iii) whether the transaction serial number TXN. SER is the latest valid serial number the block records initiated by the transaction initiator TXN.INT (i.e. Bob); (iv) whether the data format of the anticipated transaction process flow TXN.UTFE is correct, and whether the indexes (i.e. 0, 1, 2) used by the anticipated transaction process flow TXN.UTFE are all within the range of transaction attenders TXN.ATTDS; (v) whether the process time point. REC.TIME is greater than zero; (vi) whether the process created by the transaction initiator TXN.INT or the process initiator REC.INT matches with the anticipated transaction process flow TXN.UTFE, that is, whether it matches with the process [1:2]; (vii) whether the account codes recited in the “Remarks” REC.META are in line with the content of the process; for example, if this process is a transaction request sent by the buyer, the account codes other than the three account codes “0x0457 (cash paid in advance)”, “0x085D (amounts payable)”, and “0x04C5 (inventory)” will be regarded as account codes that are not in line with the content of this process; and (viii) whether the first block record Recl is signed by the private key of the first computing device 3 (Bob).

The following is an exemplary second block record Rec2 generated after the intermediate computing device 2 has validated first block record Rec1.

```
<?xml version=″1.0″ encoding=″UTF-8″?>
<record id=″0x4c5dd79ef80d859a9affdc4187f826d9aaad38505b29a44c813ae43500415b5d″>
      <rectnt>
        <descriptor>
        <txnctnt id=″0x429d943553d9e68a8b46902d4d184c0ddf38d727e480aa6adcccc8ee3eb02cd1″>
          <initiator>0xed32eb0499c2938793f42444f57befbb892264d4</initiator>
          <attenders>
  <attender><address>0xc24f05c5bfd44379a3afa7564be68cc4c2c8a3f8</address></attender><!--
Alice -->
  <attender><address>0xed32eb0499c2938793f42444f57befbb892264d4</address></attender><!--
Bob -->
  <attender><address>0x181109e6885f0ca0b00bb3a827716d52ac0ae8d7</address></attender><!--
Intermediate Computing Device --></attenders>
          <serial>0x0E</serial>
          <utfe ver=″1″>[1:2]([0:2][2:0][2:1]|[2:0][0:2][2:1])([1:2][0:2]|[0:2][1:2])</utfe>
          <type>0x01</type>
          <typepayload><null/></typepayload>
          <meta><memo>Buy cargo from Alice on 2021 Jan. 30</memo></meta></txnctnt>
          <txnsign><signature>0xc397a77ab67433c78ca54055bc3f0174291e23ceae89f19247ee7340c2b5
298f</signature></txnsign> <!-- txnctnt signature generated by Bob -->
          </descriptor>
            <ext>
<initator><address>0x181109e6885f0ca0b00bb3a827716d52ac0ae8d7</address></initiator>
<receiver><address>0xc24f05c5bfd44379a3afa7564be68cc4c2c8a3f8</address></receiver>
<prev><txnid>0xd53e008a1522b15b0998b2aa63d633b130fe9c6dc5b0738c2f36691f95de8c96</txnid>
</prev>
          <timestamp>1612296722023</timestamp>
            <meta></meta></ext></rectnt>
            <recsign><signature>0x919cd6c51a44853d2e64ddce3c87103f0f5ec16ca888a54d1ff073ad15
161854</signature></recsign> <!-- rectnt signature generated by Intermediate Computing Device
--></record>
```

With reference to the above, the main difference between the second block record Rec2 and the first block record Recl lies in the extension section EXT, the process identification code, and the record signature RECSIGN, where in the extension section EXT, the process initiator REC.INT(<initiator><address>) is the intermediate computing device 2, and the receiver of the process REC.RCVR(<receiver><address>) is the second computing device 4. The pre-process identification code REC.PREV(<prev><txnid>) quotes the process identification code (<record id>) of the first block record Recl, and the record signature RECSIGN (<recsign><signature>) is signed by the private key of the intermediate computing device 2.

After the first and second computing devices 3 and 4 receive the second block record Rec2, in addition to performing the regular validation items of the blockchain, the first and second computing devices 3 and 4 will also validate: (i) whethe ere is an initial valid block record associated with the transaction identification code (txnctnt id); (ii) whether the pre-process identification code REC.PREV is consistent with the process identification code in the first block record; (iii) whether the transaction initiator TXN.INT is one of the three transaction attenders TXN.ATTDS; (iv) whether the process created by the process initiator REC.INT and the process recipient REC.RCVR matches with the process described in the anticipated transaction process flow TXN.UTFE, that is, whether it matches with the process [2:0]; (v) whether the process tim PC REC.TIME is greater than the process time point REC.TIME in the first block record; and (vi) whether the second block record Rec2 is signed by the private key of the intermediate computing device 2,

After the second computing device 4 has validated the second block record Rec2, a third block record Rec3 is generated according to the following:

```
<?xml version=″1.0″ encoding=″UTF-8″?>
<record id=″0x40e5c3c0ab585cdeeeb323beb86ef91bc1d8043be5c60e1c3222323e0abed218″>
  <rectnt>
    <descriptor>
  <txnctnt id=″0x429d943553d9e68a8b46902d4d184c0ddf38d727e480aa6adcccc8ee3eb02cd1″>
  <initiator>0xed32eb0499c2938793f42444f57befbb892264d4</initiator>
  <attenders>
  <attender><address>0xc24f05c5bfd44379a3afa7564be68cc4c2c8a3f8</address></attender>
<!-- Alice -->
  <attender><address>0xed32eb0499c2938793f42444f57befbb892264d4</address></attender>
<!-- Bob-->
  <attender><address>0x181109e6885f0ca0b00bb3a827716d52ac0ae8d7</address></attender>
<!-- Intermediate Computing Device --></attenders>
  <serial>0x0E</serial>
  <utfe ver=″1″>[1:2]([0:2][2:0][2:1]|[2:0][0:2][2:1])([1:2][0:2]|[0:2][1:2])</utfe>
  <type>0x01</type>
  <typepayload><null/></typepayload>
  <meta><memo>Buy cargo from Alice on 2021 Jan. 30</memo></meta></txnctnt>
  <txnsign><signature>0xc397a77ab67433c78ca54055bc3f0174291e23ceae89f19247ee7340c2b5
298f</signature></txnsign> <!-- txnctnt signature generated by Bob -->
        </descriptor>
      <ext>
<initator><address>0xc24f05c5bfd44379a3afa7564be68cc4c2c8a3f8</address></initiator>
<receiver><address>0x181109e6885f0ca0b00bb3a827716d52ac0ae8d7</address></receiver>
<prev><txnid>0x4c5dd79ef80d859a9affdc4187f826d9aaad38505b29a44c813ae43500415b5d</txnid>
</prev>
  <timestamp>1612321946848</timestamp>
  <meta>
  <subjects>
  <subject type=″0x0457″ currency=″usd″>1000</subject> <!-- +1000 -->
  <subject type=″0x0475″ currency=″usd″>4000</subject> <!-- +4000 -->
  <subject type=″0x100F″ currency=″usd″>5000</subject> <!-- −5000 -->
  </subjects></meta></ext></rectnt>
  <recsign><signature>0x0f5a1d17d8a0ae4d7648825a414f85b847bfbee9d893b610191e976db12
169a2</signature></recsign> <!-- rectnt signature generated by Alice --></record>
```

With reference to the above, likewise, the main difference between the third block record Rec3 and the first block record Recl lies in the extension section EXT, the process identification code, and the record signature RECSIGN; where in the extension section EXT, the process initiator REC.INT (<initiator><address>) is Alice, and the receiver of the process REC.RCVR (<receiver><address>) is the intermediate computing device 2. The pre-process identification code REC.PREV(<prev><Nnid>) quotes the process identification code (<record id>) of the second block record Rec2; and the record signature RECSIGN (<recsign><signature>) is signed by the private key of the second computing device 4 (on behalf of Alice). It should be particularly pointed out that in the three pieces of information recorded in <meta>of the extension section EXT of this block record, “0x0457” is a decimal to hex conversion result of the IFRS account cade “Cash in advance”, which means that USD 1,000 in cash has been received; and “0x0475” is a decimal to hex conversion result of the IFRS account code “Accounts Receivable”, which means that the a sum of USD 4,000 is receivable; and “0x100F” is a decimal to hex conversion result of the IFRS account code “Sales”, which means that the entire transaction for the purchase of goods is USD 5,000.

After the intermediate computing device 2 receives the third block record Rec3, in addition to performing the regular validation items of the blockchain, the intermediate computing device 2 will also validate: (i) whether there is an initial valid block record associated with the transaction identification code (txnctnt id): (ii) whether the pre-process identification code REC.PREV is consistent with the process identification code (record id) in the second block record; (iii) whether the transaction initiator TXN.INT is one of the three transaction attenders TXN.ATTDS; (iv) whether the process created by the process initiator REC.INT and the process recipient REC.RCVR matches with the process described in the anticipated transaction process flow TXN.UTFE, that is, whether it matches with the process [0:2]; (v) whether the process time point REC.TIME is greater than the process time point REC.TIME in the second block record Rec2; (vi) whether the account code in the “Remarks” REC.META corresponds to the “Remarks” REC.META of the first block record. For example, if “0x085D (amounts payable)” is recorded in “Remarks” REC.META of the first block record, then the corresponding account code “0x0475 (accounts receivable)” should be recorded in “Remarks” REC.META of the third block record. Further, it also determines whether the amounts of the account codes corresponding to each other are offset, that is, whether the sum of the accounts receivable and accounts payable is zero; and (vii) whether the third block record Rec3 is signed by the private key of the second computing device 4 (i.e. Alice).

After the intermediate computing device 2 has validated the third block record Rec3, a fourth block record Rec4 is generated according to the following:

```
<?xml version=″1.0″ encoding=″UTF-8″?>
<record id=″0x687f5fa0142643566e832828a9893ac9d54b3f7075b7d0ceb6f8c485dffe6c86″>
  <rectnt>
    <descriptor>
    <txnctnt id=″0x429d943553d9e68a8b46902d4d184c0ddf38d727e480aa6adcccc8ee3eb02cd1″>
    <initiator>0xed32eb0499c2938793f42444f57befbb892264d4</initiator>
    <attenders>
    <attender><address>0xc24f05c5bfd44379a3afa7564be68cc4c2c8a3f8</address></attender><!--
Alice -->
    <attender><address>0xed32eb0499c2938793f42444f57befbb892264d4</address></attender><!--
Bob -->
    <attender><address>0x181109e6885f0ca0b00bb3a827716d52ac0ae8d7</address></attender><!--
Intermediate Computing Device --></attenders>
      <serial>0x0E</serial>
      <utfe ver=″1″>[1:2]([0:2][2:0][2:1]|[2:0][0:2][2:1])([1:2][0:2]|[0:2][1:2])</utfe>
      <type>0x01</type>
      <typepayload><null/></typepayload>
      <meta><memo>Buy cargo from Alice on 2021 Jan. 30</memo></meta></txnctnt>
      <txnsign><signature>0xc397a77ab67433c78ca54055bc3f0174291e23ceae89f19247ee7340c2b5
298f</signature></txnsign> <!-- txnctnt signature generated by Bob -->
          </descriptor>
          <ext>
<initator><address>0x181109e6885f0ca0b00bb3a827716d52ac0ae8d7</address></initiator>
<receiver><address>0xed32eb0499c2938793f42444f57befbb892264d4</address></receiver>
<prev><txnid>0x40e5c3c0ab585cdeeeb323beb86ef91bc1d8043be5c60e1c3222323e0abed218</txnid>
</prev>
        <timestamp>1612379574299</timestamp>
        <meta></meta></ext></rectnt>
        <recsign><signature>0x843589a7e82134bba82cc933111efcb8f429b2e9483275f01f05077405
c8501b</signature></recsign> <!-- rectnt signature generated by Intermediate Computing Device -->
      </record>
```

With reference to the above, the main difference between the fourth block record Rec4 and the second block record Rec2 lies in the extension section EXT, the process identification code, and the record signature RECSIGN; where in the extension section EXT, the process initiator REC.INT (<initiator><address>) is the intermediate computing device 2, and the receiver of the process REC.RCVR (<receiver><address>) is the first computing device 3. The pre-process identification code REC.PREV (<prev><txnid>) quotes the process identification code (<record id>) of the third block record Rec3; the record signature RECSIGN (<recsign><signature>) is signed by the private key of the intermediate computing device 2.

After the first computing device 3 has received the fourth block record Rec4, the items to be validated are substantially the same as those for the second block record Rec2 except for contents. For example, in validating the pre-process identification code REC.PREV, it is to determine whether the pre-process identification code is consistent with the process identification code in the third block record Rec3; and whether the process time point REC.TIME is greater than the process time point REC.TIME in the third block record Rec3.

After the first computing device 3 has validated the fourth block record Rec4, a fifth block record Rec5 is generated according to the following:

```
<?xml version=″1.0″ encoding=″UTF-8″?>
<record id=″0x196d00f9c75317f313261acd49698817be04725d0d120f1ef9a79e6fed91962f″>
  <rectnt>
    <descriptor>
    <txnctnt id=″0x429d943553d9e68a8b46902d4d184c0ddf38d727e480aa6adcccc8ee3eb02cd1″>
    <initiator>0xed32eb0499c2938793f42444f57befbb892264d4</initiator>
    <attenders>
    <attender><address>0xc24f05c5bfd44379a3afa7564be68cc4c2c8a3f8</address></attender><!--
Alice -->
    <attender><address>0xed32eb0499c2938793f42444f57befbb892264d4</address></attender><!--
Bob -->
    <attender><address>0x181109e6885f0ca0b00bb3a827716d52ac0ae8d7</address></attender> <!--
Intermediate Computing Device --></attenders>
      <serial>0x0E</serial>
      <utfe ver=″1″>[1:2]([0:2][2:0][2:1]|[2:0][0:2][2:1])([1:2][0:2]|[0:2][1:2])</utfe>
      <type>0x01</type>
      <typepayload><null/></typepayload>
      <meta><memo>Buy cargo from Alice on 2021 Jan. 30</memo></meta></txnctnt>
      <txnsign><signature>0xc397a77ab67433c78ca54055bc3f0174291e23ceae89f19247ee7340c2b5
298f</signature></txnsign> <!-- txnctnt signature generated by Bob -->
        </descriptor>
        <ext>
<initator><address>0xc24f05c5bfd44379a3afa7564be68cc4c2c8a3f8</address></initiator>
<receiver><address>0x181109e6885f0ca0b00bb3a827716d52ac0ae8d7</address></receiver>
<prev><txnid>0x687f5fa0142643566e832828a9893ac9d54b3f7075b7d0ceb6f8c485dffe6c86</txnid>
</prev>
      <timestamp>1612466007640</timestamp>
      <meta></meta></ext></rectnt>
      <recsign><signature>0x73b0178e878ae64c99e06b5395cb3ca4933d9ac620cd9d0b94ee442bc7a
77932</signature></recsign> <!-- rectnt signature generated by Bob -->
      </record>
```

With reference to the above, the main difference between the fifth block record Rec5 and the fourth block record Rec4 lies in the extension section EXT, the process identification code, and the record signature RECSIGN; where in the extension section EXT, the process initiator REC.INT (<initiator><address>) is the first computing device 3, the receiver of the process REC.RCVR (<receiver><address>) is the intermediate computing device 2; the pre-process identification code REC.PREV (<prev><txnid>) quotes the process identification code (<record id>) of the fourth block record Rec4; and the record signature RECSIGN (<recsign><signature>) is signed by the private key of the first computing device 3 (Bob).

After the intermediate computing device 4 has received the fifth block record Rec5, the items to be validated are substantially the same as those for the fourth block record Rec4 except for contents. For example, in validating the pre-process identification code REC.PREV, it is to determine whether the pre-process identification code is consistent with the process identification code in the fourth block record Rec4; and whether the process time point REC.TIME is greater than the process time point REC.TIME in the fourth block record Rec4.

Likewise, after the second computing device 4 has validated the fifth block record Rec5, a sixth block record Rec6 is generated according to the following:

```
<?xml version=″1.0″ encoding=″UTF-8″?>
<record id=″0x3af643174a3c5a9380c98e15acd3f9d70707f34b3a6ac9ee5017159df6f3fadb″>
  <rectnt>
    <descriptor>
    <txnctnt id=″0x429d943553d9e68a8b46902d4d184c0ddf38d727e480aa6adcccc8ee3eb02cd1″>
    <initiator>0xed32eb0499c2938793f42444f57befbb892264d4</initiator>
    <attenders>
    <attender><address>0xc24f05c5bfd44379a3afa7564be68cc4c2c8a3f8</address></attender><!--
Alice -->
    <attender><address>0xed32eb0499c2938793f42444f57befbb892264d4</address></attender> <!--
Bob -->
    <attender><address>0x181109e6885f0ca0b00bb3a827716d52ac0ae8d7</address></attender> <!--
Intermediate Computing Device --></attenders>
        <serial>0x0E</serial>
        <utfe ver=″1″>[1:2]([0:2][2:0][2:1]|[2:0][0:2][2:1])([1:2][0:2]|[0:2][1:2])</utfe>
        <type>0x01</type>
        <typepayload><null/></typepayload>
        <meta><memo>Buy cargo from Alice on 2021 Jan. 30</memo></meta></txnctnt>
        <txnsign><signature>0xc397a77ab67433c78ca54055bc3f0174291e23ceae89f19247ee7340c2b5
        298f</signature></txnsign> <!-- txnctnt signature generated by Bob -->
          </descriptor>
          <ext>
<initator><address>0xed32eb0499c2938793f42444f57befbb892264d4</address></initiator>
<receiver><address>0x181109e6885f0ca0b00bb3a827716d52ac0ae8d7</address></receiver>
<prev><txnid>0x196d00f9c75317f313261acd49698817be04725d0d120f1ef9a79e6fed91962f</txnid></
prev>
      <timestamp>1612502024762</timestamp>
      <meta></meta></ext></rectnt>
      <recsign><signature>0xaac35983d61d75d63f51ab08921145020989ef4a976886899fa2bb75845b
1b34</signature></recsign> <!-- rectnt signature generated by Alice -->
        </record>
```

With reference to the above, the main difference between the sixth block record Rec6 and the fourth block record Rec4 lies in the extension section EXT, the process identification code, and the record signature RECSIGN; where in the extension section EXT, the process initiator REC.INT (<initiator><address>) is the second computing device 4; and the record signature RECSIGN (<recsign><signature>) is signed by the private key of the second computing device 4 (i.e. Alice). After the intermediate computing device 4 has received the sixth block record Rec6, the items and contents thereof to be validated are substantially the same as those of the fifth block record Rec5.

Various ways to extract/obtain the transaction records from the blockchain network shall be specified hereinbelow. Firstly, the block records belonging to the same transaction event in the blockchain network is collected and then sorted in the order of the process, and then the signature and the time sequence are validated. Also, it is to validate whether the transaction process flow matches with the anticipated transaction process flow TXN.UTFE defined in the block records. If it is confirmed that the transaction process flow is correct, the account codes specified in the “Remarks” REC.META are sorted into assets or liabilities in sequential orders. As such, the status of the assets and liabilities generated by the transaction between the parties in transaction, and the primary contents of the transaction can be clearly presented.

For example, any one of the computing devices in the blockchain network may obtain the first to sixth block records Rec1-6 through the regular expression (abbreviation: regexp) by searching based on the transaction identification code TXNCTNT.ID (<txnctnt id=“0x429d943553d9e68a8b46902d4d184c0ddf38d727e480aa6adcccc8ee3eb02cd1”>), for example, READ (DB TXN, REC1 6.rectnt.decriptor.txnctnt:id). After effecting the validation of the data in the block records Rec1-6, for example, checking the time sequence, validating the private key signature and the transaction process flow, associated amounts and information, such as “cash received in advance”, “cash paid in advance”, “accounts receivable”, “accounts payable”, “sales”, and “inventory”, and the corresponding account codes may be exported from the “Remarks” REC.META of the process in the first and third block records Rec1 and Rec3.

As such, the contents of this transaction, and the rights and obligations of the parties involved in the transaction may be clearly presented. More importantly, the data exported are in line with the double-entry bookkeeping method of the real economy accounting system. As such, this blockchain transaction records may be easily integrated with the real economy accounting system. Likewise, various transaction records of the real economy accounting system may also be recorded into the blockchain through the system or method according to the present invention, enabling the real economy accounting system possesses the characteristics of the blockchain technology, such as openness, transparency, and tamper-resistance.

On the other hand, if it is intended to make an inquiry on all the transaction records and the status of assets and liabilities of a user, one can obtain all the records by using the user account address (such as the public key) as a searching keyword by way of the regular expression on any one of the computing devices in the blockchain network. The data and information in all the block records of all transaction records of the use can then be validated, and all transaction contents and the corresponding account codes exported from the “Remarks” REC.META of the process in the block records. After settlement, one can then obtain the user's assets and liabilities, and establish the user's complete balance sheet which can be integrated with the existing real accounting system. Furthermore, other searching items such as transaction time, transaction type, currency type, and/or trading partner(s) can be added to further filter the transaction data to be obtained, for example, transaction records of a particular transaction type performed by a user in a particular year, etc.

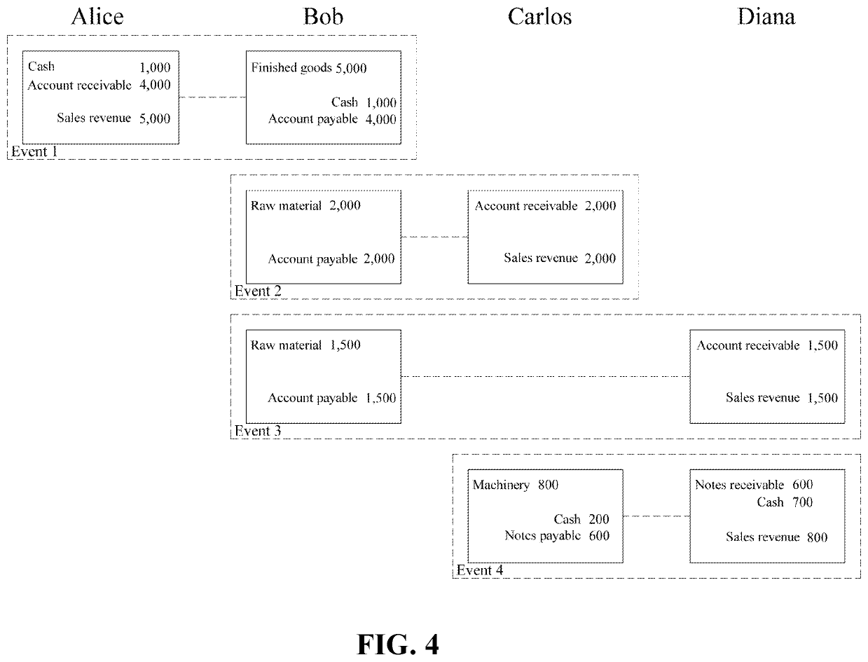

Reference is made to FIG. 4, which schematically shows the transaction scenario of each user in the second embodiment of the present invention. The second embodiment as described below shows that the system and method according to the present invention may realize transactions between multiple users, and clarify the rights and obligations between the users easily. As shown in FIG. 4, there are four transaction events underlying the scenario presumed in this embodiment. Event 1 is the one similar to the event presented in the first embodiment mentioned hereinbefore. In this event, Alice sells goods worth of USD 5,000 to Bob, and Bob has paid USD 1,000 cash in advance, so Alice still has accounts receivable of USD 4,000. In Event 2, Carlos sold raw materials worth of USD 2,000 to Bob, So Carlos has accounts receivable of USD 2,000. In Event 3, Diana sold raw materials worth of USD 1,500 to Bob, so Diana has accounts receivable of USD 1,500. In Event 4, Diana sold machinery worth of USD 800 to Carlos, and Carlos had paid USD 200 cash in advance and issued a note of USD 600 to Diana.

Now the account subjects and the corresponding IFRS account codes used in this embodiment are described hereinafter. The account code of “cash on hand” is “1111”, and the decimal to hex conversion result is “457”, so the code used in this embodiment is “0x0457”. The account code of “notes receivable” is “1131”, and the decimal to hex conversion result is “046B”, so the code used in this embodiment is “0x046B”. The account code of “accounts receivable” is “1141”, and the decimal to hex conversion result “0475”, so the code used in this embodiment is “0x0475”. The account code of “finished goods” is “1221”, and the decimal to hex conversion result is “04C5”, so the code used in this embodiment is “0x04C5”. The account code of “raw materials” is “1226”, and the decimal to hex conversion result is “04CA”, so the code used in this embodiment is “0x04CA”. The account code of “machinery” is “1441”, and the decimal to hex conversion result is “05A1”, so the code used in this embodiment is “0x05A1”. The account code of “notes payable” is “2131”, and the decimal to hex conversion result is “0853”, so the code used in this embodiment is “0x0853”. The account code of “accounts payable” is “2141”, and the decimal to hex conversion result is “085D”, so the code used in this embodiment is “0x085D”. The account code of “sales revenue” is “4111”, and the decimal to hex conversion result is “100F”, so the code used in this embodiment is “0x100F”.

Since Event 1 has been described in detail in the foregoing first embodiment, relevant descriptions may be omitted. The following description will begin from Event 2. As most of the processes and records in each of the events are similar to those in the first embodiment, the following will only explain on the significant differences, that is how the actual transaction content is presented in the data structure of the block records. Taking Event 2 as an example, in the “Remarks” REC.META in the first block record Rec1, the following is specified: ‘<subject type=“0x04CA” currency =“usd”>2000</subject><!--+2000-->’, and ‘<subject type=“0x085D” currency=“usd”>2000</subject><!-- −2000-->’; where “0x04CA” means that the account subject is “raw material” (account code is “1226”), and its value is USD 2,000, and “0x085D” means that the account code is “Accounts Payable (account code is “2141”)”, and its amount is USD 2,000. In other words, Bob buys raw materials worth of USD 2,000, and the fee is accounts payable. Of course, the first block record Recl also records that the seller is Carlos.

Taking Event 2 as an example again, in the “Remarks” REC.META in the third block record Rec3, the following is specified: ‘<subject type=“0x0475” currency =“usd”>2000</subject><! +2000 -->’ and ‘<subject type=“0x100F” currency=“usd”>2000</subject><!-- −2000 -->’, where “0x0475” means that the account code is “Accounts Receivable (accounting code is “1141”)”, and its value is USD 2,000, and “0x100F” means that the account code is “sales revenue (account code is “4111”)” and its amount is USD 2,000. In other words, this transaction gives Carlos a sales income of USD 2,000, all of which are accounts receivable. As mentioned above, taking Event 2 as an example, the “Remarks” REC.META in the first and third block records, Rec1 and Rec3, has specifically recorded the contents of this transaction and the current payment status. And the contents of the records are in line with the double-entry bookkeeping method of the real economy accounting system, and thus can be directly exported from the blockchain network and written into the real economy accounting system.

Furthermore, taking Event 3 as an example, in the “Remarks” REC.META in the first block record Recl, the following is specified: ‘<subject type=“0x04CA” currency=“usd”>1500</subject><! -- +1500 -->’ and ‘<subject type=“0x085D” currency=“usd”>1500</subject><!-- −1500 -->’; where “0x04CA” means that the account subject is “raw materials (account code is “1226”)”, and its value is USD 1,500, and “0x085D” means that the account subject is “Accounts Payable (account code is “2141”)” and its amount is USD 1,500. In other words, Bob buys raw materials worth of USD 1,500, and the fee is an account payable. Of course, the first block record Recl also records that the seller is Diana.

Also, taking again Event 3 as an example, in the “Remarks” REC.META in the third block record Rec3, the following is specified: ‘<subject type=“0x100F” currency=“usd”>1500</subject><!-- +1500 -->’ and ‘<subject type=“0x0475” currency=“usd”>1500</subject><!-- −1500 -->’, where “0x0475” means that the account subject is “Accounts receivable (account code is “1141”)”, and its value is USD 1,500; and “0x100F” means that the account subject is “Sales revenue (account code is “4111”)”, and its amount is USD 1,500. In other words, this transaction gives Diana a USD 1,500 sales income, all of which are accounts receivable.

Finally, taking Event 4 an example, in the “Remarks” REC.META in the first block record Recl, the following is specified: ‘<subject type=“0x05A1” currency =“usd”>800</subject><!-- +800 -->’, ‘<subject type=“0x0457” currency=“usd”>200</subject><!-- −200 -->’ and ‘<subject type =“0x0853” currency=“usd”>600</subject><!-- −600 -->’; where “0x05A1” means that the account subject is “machine tool (account code is “1441”)”, and its value is USD 800; and “0x0457” indicates that the account subject is cash (account code is “1111”), and its amount is USD 200; and “0x0853” indicates that the account subject is “notes payable (account code is “2131”)”, and the amount is USD 600. That is to say, Carlos has purchased a machine tool worth of USD 800, has paid USD 200 in cash in advance, and still has notes payable of USD 600. Of course, the first block record Recl also records that the seller is Diana.

Also, taking Event 4 as an example, in the “Remarks” REC.META in the third block record Rec3, the following is specified: ‘<subject type=“0x100F” currency=“usd”>800</subject><!-- −800 -->’, ‘<subject type=“0x0457” currency =“usd”>200</subject><!-- +200 -->’ and ‘<subject type=“0x046B” currency=“usd”>600</subject><!-- +600 -->’; where “0x100F” means that the account subject is “sales revenue (account code is “4111”)”, and its value is USD 800; and “0x0457” means that the account subject is “cash (account code is “1111”)” and the amount is USD 200; and “0x046B” indicates that the account subject “notes receivable (account code is “1131”)” and the amount is USD 600. In other words, this transaction gives Diana a USD 800 sales income, in which a cash of USD 200 has been received in advance, and has notes receivable in the amount of USD 600.

In summary, the present invention uses the distributed ledger presented by the credibility of the blockchain technology to specifically realize the recording and processing of the rights and obligations between multiple entities, and these rights and obligations are open and transparent. Anyone can have access and verify, and the characteristics of the blockchain render it impossible for the transaction contents to be tampered with by these entities. Furthermore, these transaction records can be easily settled, and the assets and liabilities of a single entity can be easily presented. More importantly, these transactions or the rights and obligations between the entities can be processed and recorded using the blockchain network, and can be exported from the blockchain network and form the ledger of the standard accounting practices of the real economy accounting system. As such, blockchain technology may be integrated into the real economy accounting system, that is, the real economy accounting system may be perfectly integrated with the accounting method of the blockchain.

Corresponding to the above method embodiment, the present disclosure also describes an embodiment of a blockchain-based transaction processing apparatus. The embodiment of the blockchain-based transaction processing apparatus of the present disclosure can be applied to an electronic device. The apparatus embodiment can be implemented by software, or by hardware or a combination of software and hardware. Taking software implementation as an example, as an apparatus in a logical sense, it is formed by reading the corresponding computer program instructions in the non-volatile memory into the memory through the processor of the electronic device where it is located.

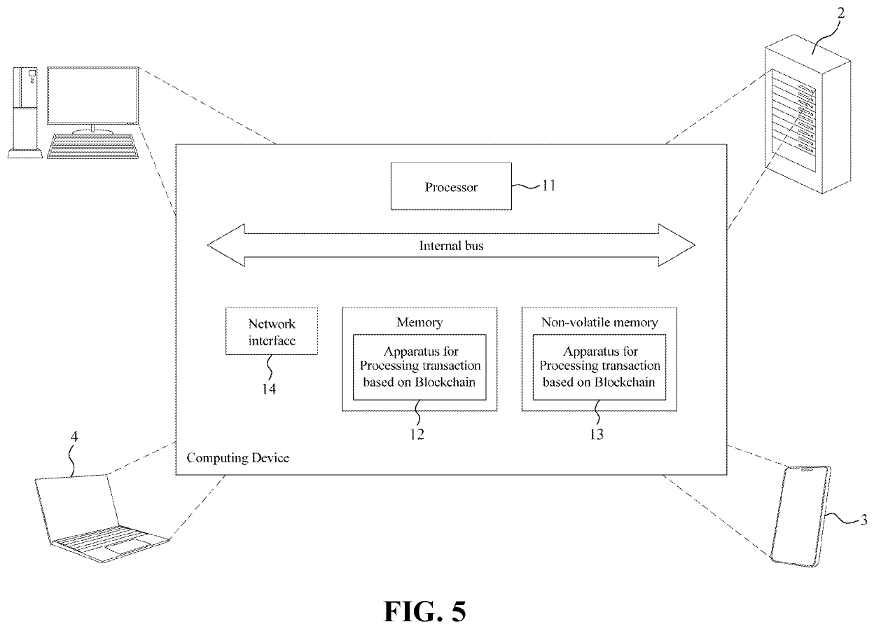

In terms of hardware, as shown in FIG. 5, which is a hardware block diagram of the computing device where the blockchain-based transaction processing apparatus of the present disclosure is located, and it may be used for any of the operations described with respect to the various implementations discussed herein. For example, the computing device may be included, at least in part, in one or more of the intermediate computing device(s) 2, the first computing device(s) 3 and the second computing device(s) 4 described herein. As those skilled in the art will appreciate, the computing device may include an operating system (e.g., WINDOWS®, OS2, UNIX®, LINUX®, SOLARIS®, MacOS, Android, iOS, etc.) as well as various conventional support software and drivers typically associated with the computing device. Further, the blockchain network may be implemented using technologies such as, for example, Ethereum GETH, PARITY, eth-lightwallet, or other suitable blockchain interface technologies.

In addition to the processor 11, the memory 12, the network interface 14, and the non-volatile memory 13 shown in FIG. 5, the electronic device in which the apparatus is located in the embodiment may generally include other hardware according to the actual function of the electronic device, details of which will not be described herein.

The processor(s) 11 may be configured to process instructions for execution within the computing device. The processor(s) 11 may include single-threaded processor(s), multi-threaded processor(s), or both. The processor(s) 11 may be configured to process instructions stored in the memory 12 or on the non-volatile memory 13. The processor(s) 11 may include hardware-based processor(s) each including one or more cores. The processor(s) 11 may include general purpose processor(s), special purpose processor(s), or both.

The memory 12 may include a transitory memory, a random access memory (RAM), and/or a non-volatile memory in a computer-readable medium, such as a read-only memory (ROM) or a flash RAM. The memory is an example of a computer-readable medium. The computer-readable medium includes either permanent or non-permanent, either removable or non-removable medium, which can store information by any method or technology. Information may be computer-readable instructions, data structures, modules of a program, or other data. Examples of computer storage media include, but are not limited to, a phase change memory (PRAM), a static random access memory (SRAM), a dynamic random access memory (DRAM), other types of random access memory (RAM), and a read-only memory (ROM), an electrically erasable programmable read-only memory (EEPROM), a flash memory or other memory technologies, a read-only disc, a read-only memory (CD-ROM), a digital versatile disc (DVD) or other optical storage, a magnetic tape cartridge, magnetic disk storage, a quantum memory, graphene-based storage media, or other magnetic storage devices or any other non-transmission media can be used to store information that can be accessed by computing devices. As defined herein, computer-readable media does not include temporary computer-readable media (transitory media), such as modulated data signals and carrier waves.

The network interface 14 may include one or more network interface controllers (NICs) or other types of transceiver devices configured to send and receive communications over one or more networks, such as the blockchain network (peer-to-peer network), using any network protocol. In some implementations, the computing devices may communicate with one another, or with other computing devices, using one or more networks. Such networks may include public networks such as the internet, private networks such as an institutional or personal intranet, or any combination of private and public networks. The networks may include any type of wired or wireless network, including but not limited to local area networks (LANs), wide area networks (WANs), wireless WANs (WWANs), wireless LANs (WLANs), mobile communications networks (e.g., 4G, 5G, Edge, etc.), and so forth. In some implementations, the communications between computing devices may be encrypted or otherwise secured. For example, communications may employ one or more public or private cryptographic keys, ciphers, digital certificates, or other credentials supported by a security protocol, such as any version of the Secure Sockets Layer (SSL) or the Transport Layer Security (TLS) protocol.

The system of the present invention may include any number of computing devices of any type. The computing device(s) may include, but are not limited to: a personal computer, a smartphone, a tablet computer, a wearable computer, an implanted computer, a mobile gaming device, an electronic book reader, an automotive computer, a desktop computer, a laptop computer, a notebook computer, a game console, a home entertainment device, a network computer, a server computer, a mainframe computer, a distributed computing device (e.g., a cloud computing device), a microcomputer, a system on a chip (SoC), a system in a package (SiP), and so forth. Although examples herein may describe computing device(s) as physical device(s), implementations are not so limited. In some examples, a computing device may include one or more of a virtual computing environment, a hypervisor, an emulation, or a virtual machine executing on one or more real computing devices. In some examples, two or more computing devices may include a cluster, cloud, farm, or other grouping of multiple devices that coordinate operations to provide load balancing, failover support, parallel processing capabilities, shared storage resources, shared networking capabilities, or other aspects.

Various functional components or blocks have been described herein. As will be appreciated by persons skilled in the art, in many embodiments, the functional blocks will be implemented through circuits (either dedicated circuits, or general purpose circuits, which operate under the control of one or more processors and coded instructions), which will typically comprise transistors or other circuit elements that are configured in such a way as to control the operation of the circuity in accordance with the functions and operations described herein. As will be further appreciated, the specific structure or interconnections of the circuit elements will typically be determined by a compiler, such as a register transfer language (RTL) compiler. RTL compilers operate upon scripts that closely resemble assembly language code, to compile the script into a form that is used for the layout or fabrication of the ultimate circuitry. Indeed, RTL is well known for its role and use in the facilitation of the design process of electronic and digital systems. As well, in embodiments implemented using general purpose circuits, which operate under the control of one or more processors and coded instructions, the general-purpose circuitry becomes a special-purpose machine, once the instructions are loaded.

While various exemplary embodiments of the disclosure have been described above, it should be understood that they have been presented for purposes of example only, not limitations. Modifications and variations are possible in light of the above teachings or may be acquired from practicing of the disclosure, without departing from the breadth or scope of the present invention.

1. A computer-implemented method for processing a transaction, the method comprising:
receiving, by an intermediate computing device, a first block record from a first computing device in a peer-to-peer network, wherein the first block record comprises a transaction initiator, a plurality of transaction attenders, and a transaction amount receivable or payable;
generating, by the intermediate computing device, a second block record and sending the second block record to the first computing device after having validated the first block record;
receiving, by the intermediate computing device from a second computing device, a third block record that is generated by the second computing device after having validated the second block record obtained from at least one of the first computing device and the intermediate computing device, wherein the third block record comprises the transaction initiator, the transaction attenders, and a further transaction amount receivable or payable;
wherein when the transaction amount payable is recorded in the first block record, the further transaction amount receivable is recorded in the third block record, and sum of the transaction amount payable recorded in the first block record and the further transaction amount receivable recorded in the third block record is zero;
generating, by the intermediate computing device, a fourth block record and sending the fourth block record to the second computing device after validating the third block record;
receiving, by the intermediate computing device from the first computing device, a fifth block record that is generated by the first computing device after having validated the fourth block record obtained from at least one of the second computing device and the intermediate computing device;
receiving, by the intermediate computing device from the second computing device, a sixth block record that is generated by the second computing device after having validated the fifth block record obtained from at least one of the first computing device and the intermediate computing device in the peer-to-peer network; and
broadcasting, by the intermediate computing device, the first, second, third, fourth, fifth, and sixth block records to a plurality of further computing devices in the peer-to-peer network after validating the fifth and sixth block records.

2. The method of claim 1, wherein the first and fifth block records are generated by using a private key of the first computing device; the third and sixth block records are generated by using a private key of the second computing device; and the second and fourth block records are generated by using a private key of the intermediate computing; device.

3. The method of claim 2, wherein each of the first, second, third, fourth, fifth, and sixth block records comprises:
a process identification code;
a transaction identification section comprising; a transaction content and a transaction signature generated by a private key of the transaction initiator, the transaction content comprising a transaction identification code, the transaction initiator, the transaction attenders, and a transaction serial number;
an extension section -comprising a process initiator, a process recipient, a pre-process identification code, a process time point, and a remark of the process in which the transaction amount receivable or payable is recorded; and
a record signature generated by a private key of the process initiator;
wherein the process identification code is a hash value of the transaction identification section and the extension section; the transaction identification code is a hash value of the transaction content in which the transaction identification code is excluded; and the remark of the process further records account codes corresponding to the transaction amount receivable or payable.

4. The method of claim 3, wherein in validating the first block record, the intermediate computing device is configured to verify:
whether the transaction initiator is consistent with the process initiator;
whether the transaction initiator is one of the plurality of transaction attenders;
whether the transaction serial number is a latest valid serial number in the block record initiated by the transaction initiator; and
whether the process time point is greater han zero.

5. The method of claim 3, wherein in validating the third block record, the intermediate computing device is configured to verify:
whether an initial valid block record associated with the transaction identification code exists in the peer-to-peer network;
whether the pre-process identification code is consistent with the process identification code in the second block record;
whether the transaction initiator is one of the plurality of transaction attenders;
whether the process time point is greater than or equal to the process time point of the second block record; and
whether the sum of the transaction amount receivable or payable recorded in the first block record and the further transaction amount payable or receivable recorded in the third block is zero.

6. The method of claim 3, wherein in validating the fifth and sixth block records, the intermediate computing device is configured to verify:
whether an initial valid block record associated with the transaction identification code exists in the peer-to-peer network:
whether the pre-process identification code in the fifth block record is consistent with the process identification code in the fourth block record;
whether the pre-process identification code in the sixth block record is consistent with the process identification code in the fifth block record;
whether the transaction initiator is one of the plurality of transaction attenders; and whether the process time point is greater than or equal to the process time point of the fourth block record;
whether the fifth block record is signed by the private key of the first computing device; and
whether the sixth block record is signed by the private key of the second computing device.

7. The method of claim 3, wherein in response to a request to obtain the transaction record from the peer-to-peer network, any one of the computing devices in the peer-to-peer network obtains the first, second, third, fourth, fifth, and sixth block records by searching the transactionidentification code; and exports the transacttion amount receivable, the transaction amount payable, and the associated account codes from the remarks of the processes of the first and third block records after having validated the obtained block records,

8. The method of claim 3, wherein in response to a request to obtain all the transaction records made by the transaction initiator from the peer-to-peer network, any one of the computing devices in the peer-to-peer network obtains all the transaction records by searching a public key of the transaction initiator, and exports the transaction amount receivable, the transaction amount payable, and the associated account codes from the remarks of the processes of all the block records after having validated all the obtained block records.

9. A computer-implemented system for processing a transaction, comprising:
an intermediate computing device;
one or more memory devices communicatively coupled to the intermediate computing device and having a tangible, non-transitory, machine-readable medium storing one or more instructions that, when executed by the intermediate computing device, perform one or more operations comprising:
receiving, by the intermediate computing device, a first block record from a first computing device, wherein the first block record comprises a transaction initiator, a plurality of transaction attenders, and a transaction amount receivable or payable;
generating, by the intermediate computing device, a second block record and sending the second block record to the first computing device after validating the first block record;
receiving, by the intermediate computing device from a second computing device, a third block record that is generated by the second computing device after having validated the second block record obtained from at least one of the first computing device and the intermediate computing device, wherein the third block record comprises the transaction initiator, the plurality of transaction attenders, and a further transaction amount receivable or payable; wherein when the first block record records the transaction amount payable, the third block record records the further transaction amount receivable, and sum of the transaction amount payable recorded in the first block record and the further transaction amount receivable recorded in the third block record is zero;
generating, by the intermediate computing device, a fourth block record and sending the fourth block record to the second computing device after validating the third block record;
receiving, by the intermediate computing device from the first computing device, a fifth block record that is generated by the first computing device after having validated the fourth block record obtained from at least one of the second computing device and the intermediate computing device;
receiving, by the intermediate computing device from the second computing device, a sixth block record that is generated by the second computing device after having validated the fifth block record obtained from at least one of the first computing device and the intermediate computing device; and
sending, by the intermediate computing device, the first, second, third, fourth, fifth, and sixth block records to a plurality of further computing devices after validating the fifth and sixth block records.

10. A tangible, non-transitory, machine-readable medium storing one or more instructions that, when executable by an intermediate computing device, perform one or more operations comprising:
receiving, by the intermediate computing device, a first block record from a first computing device in a peer-to-peer network, wherein the first block record comprises a transaction initiator, a plurality of transaction attenders, and a transaction amount receivable or payable;
generating, by the intermediate computing device, a second block record and sending the second block record to the first computing device after having validated the first block record;
receiving, by the intermediate computing device from a second computing device, a third block record that is generated by the second computing device after having validated the second block record obtained from at least one of the first computing device and the intermediate computing device, wherein the third block record comprises the transaction initiator, the transaction attenders, and a further transaction amount receivable or payable;
wherein when the transaction amount payable is recorded in the first block record, the further transaction amount receivable is recorded in the third block record, and sum of the transaction amount payable recorded in the first block record and the transaction amount receivable recorded in the third block record is zero;
generating, by the intermediate computing device, a fourth block record and sending the fourth block record to the second computing device after validating the third block record;
receiving, by the intermediate computing device from the first computing device, a fifth block record that is generated by the first computing device after having validated the fourth block record obtained from at least one of the second computing device and the intermediate computing device;
receiving, by the intermediate computing device from the second computing device, a sixth block record that is generated by the second computing device after having validated the fifth block record obtained from at least one of the first computing device and the intermediate computing device; and
sending, by the intermediate computing device, the first, second, third, fourth, fifth, and sixth block records to a plurality of further computing devices after validating the fifth and sixth block records.
